(19) United States
(12) Patent Application Publication
(10) Pub. No.: US 2003/0001887 A1
(43) Pub. Date: Jan. 2, 2003

(54) Method and system for communicating user specific infromation

(76) Inventor: James E. Smith IV, Redwood City, CA (US)

Correspondence Address: Jurgen K. Vollrath, 1222 Settle Ave., San Jose, CA, 95125, US

(21) Appl. No.: 09/894,613

(22) Filed: Jun. 27, 2001

(51) Int. Cl. G09G 5/00

(52) U.S. Cl. 345/741

(57) ABSTRACT

In digital content delivery devices, the user experience is enhanced by tailoring the content and the way the content is delivered to the user's information which includes demographic information, user preferences, and user interests. This is achieved by providing a protocol that enables devices to communicate their content and delivery preferences, and defines the content provider's rules. The delivery of additional content to the user can be invoked by the rules in response to the user information. By licensing content to a specific user, the unauthorized distribution of content can be controlled. The user specific information can also be transferred to other intelligent devices by providing the information on a portable device for interfacing with the other intelligent devices. In this way, a user's preference settings, for example, regarding his or her motor vehicle seats and mirrors, can be transferred to any such device by downloading the user information and rules from the portable device. Similarly, a use could take computer setting preferences, in conjunction with a user identity, from computer to computer.

### FIELD OF THE INVENTION

The invention relates to a method and system for communicating digital content. In particular it relates to protecting digital content and enhancing the user experience.

### BACKGROUND OF THE INVENTION

With the information age, the need for distributing information effectively is becoming increasingly important. Not only is the appetite for rapid content delivery increasing from day to day, but peoples' expectations regarding the manner in which content is being presented, and the types of content that are available are becoming ever more diverse. Thus there is a simultaneous need to improve the user experience while also addressing security issues.

One of the issues raised by digital content delivery is the challenge regarding the protection of users on the Internet and protection of content against unwanted intrusion. Due to the speed and flexibility of the medium, digital content delivery is a prime target for illegal and unethical activity. With the incorporation of the Internet into out daily lives, children are increasingly at risk of exposure to unwanted material whether it be of a violent or sexually explicit nature. Some service providers on the Internet, such as AOL, have sought to deal with the problem by incorporating filtering software, thereby denying access to unwanted sites as and when these come to light. Thus they start with the full complement of sites and seek to exclude unwanted sites. The problem with this approach is that filtering software is only partially effective in identifying offensive sites, thus much unwanted material remains available. Furthermore, it is virtually impossible and highly labor intensive to manually verify the suitability of all sites. The ever increasing number of existing sites makes this approach a losing battle. AOL also provides an AOL community where approved sites are specifically addressable by hyperlinks. This, however, does not prevent a user typing in any web address, nor does it distinguish between one user and the next. All users are presented with the same information.

Another aspect of the protection problem involves the content itself. Digital content is at risk of being intercepted by unauthorized persons. Elaborate encryption schemes have been devised to deal with the problem. However these are effective only for so long as the content is in its encrypted form. These schemes provide the content provider with no protection against unwanted copying and distribution once the recipient has decrypted the content. Thus, not only are the users and the data at risk, but the content providers themselves are facing new challenges. A content provider may be providing content to a select group of users with the intention that further distribution be strictly controlled. However, even if the content is initially encrypted, the security falls away once an authorized recipient decodes the information. Thereafter, the user is free to save or further distribute the content in unprotected form. This was recently highlighted in the recording industry as it related to the unauthorized copying and delivery of copyright protected digital content. With little regard to the copyright laws, users swapped music over the Internet, in the form of MP3 files.

However security and protection of content are not the only issues. The presentation of the content itself, and the whole user experience remains to be addressed. The user is essentially a passive recipient. His or her preferences are not taken into consideration. Traditionally, information has been distributed in hard copy formats such as books, magazines, and newspapers, that permit little or no user interaction. This trend has carried over into the electronic media industry and to the distribution of digital content. Television, videos, tapes and CD's leave users without much flexibility or choice regarding the type of content. Their choice is essentially one of either accepting the same generic content that is offered to everyone else or of opting out altogether. Only to a limited extent, has user choice become available through the use of cable television and pay-per-view television. With the development of the Internet, some additional user choice has been made available, by providing the user with the flexibility to access only those sites and material that the user wishes to see. Advertisers on the Internet even have the ability to target user groups with targeted advertising based on profiles gathered on the user groups, for example, through the use of cookies.

However, the pushing of advertising leaves the recipient with no say in the matter. Furthermore, it is based on information gathered generally on all users of a particular computer and is of a generic nature, based on the browsing habits of all of the users of a particular computer. In a household where more than one user may be accessing the Internet by means of the same computer, no distinction is made between a five year old child, a teenager, and an adult. Each of these users have different interests which are not individually addressed. It also leaves children exposed to undesirable content, since web sites are generally available and no distinction is made between the various users accessing the web sites. As mentioned above, some service providers like AOL provide a filtering service that filters out undesirable material and blocks access to certain identified sites. However, the sites are filtered purely on a generalized basis, without taking into account the age, sex, cultural background, or other parameters of any particular user.

Furthermore, since the gathered information is tied to a particular machine, there is no facility for allowing a user to have the information that was gathered follow him or her around to other machines.

The present invention seeks to address these issues of user and content protection, and enhancing the user experience by allowing the content provider and the recipient to express how much content they wish to provide and what they wish to receive.

### SUMMARY OF THE INVENTION

The invention deals with a method of protecting digital content, content providers, and consumers, and with a method of structuring information to meet the needs of the sender and the recipient. This is achieved by enabling the user's machine and the content or the machine providing the content. It allows both parties to the communication to specify what content they are willing to send and receive, the form of the content, and the terms on which it is to be made available. The invention thus provides a method of protecting a user against undesirable content on a computer by requiring user identification and, based on the user's predetermined criteria, providing the user with user specific content. This may involve providing a browser interface having no general file or web address entry location. Instead, access may be provided to web sites and files through linked lists that can be selected by the user. The invention, further, provides for the assimilation of content from various sources such as the Internet and a CD-ROM. This allows data rich content such as video clips or sound files to be rapidly accessible from a CD-ROM and integrated into content received off the Web. According to the invention, content can be gathered from more than one source. Insofar as the same content is available from two sources, e.g. a remote source like an internet server, and a local source, e.g. a CD-ROM, the protocol makes a determination based on user preferences as to the most appropriate source. For instance, if the content varies with time, a current version from the internet may be appropriate. If the content is not time sensitive, on the other hand, the protocol may base the source on the download time and choose the local source over the remote source. Another feature of the protocol is that it informs a device of the content available, e.g. a CD-ROM with enabled content will inform the device what content exists on the CD-ROM, e.g. a music file and a video file, thereby allowing the device to access this content locally when required. Thus the protocol provides the advantages of a cache without ever having to first download the content.

The invention also deals with the creation of electronic environments that are targeted to the individual, and ways of allowing the user to carry this information around with him/herself to allow for the recreation of the user's environment on any corresponding intelligent device, no matter where the user happens to find him or herself. Thus it allows a user, for example, to carry a portable identification device (PID) such as a key ring device that includes a method of storage of personal information and communication. For example, the PID can interface with a motor vehicle computer to set mirror, seat and radio channel settings to reflect the user's preferences. In the case of a child's PID, a motor vehicle ignition or gear shifting mechanism can be disabled. The interacting computer, for example, the motor vehicle computer can be pre-enabled to communicate with the portable device or can be enabled by the portable device. Communication between the portable device and the computer or other intelligent device can take place over a physical connection or wireless connection, e.g., Bluetooth.

The invention also defines a user specific or purpose specific computer or device, such as a childrens' computer that limits user access to approved sites. The device includes a browser interface that prevents web addresses to be typed for purposes of retrieving sites. Instead it relies on hyperlinks to gain access to pre-approved sites. Preferably the device is enabled to communicate with other devices according to a certain protocol that allows information to be exchanged between communicating devices. The communicating parties determine what information they are willing to divulge and what information they are prepared to make available based on such information. In the case of a childrens' computer some of the information made available from the childrens' computer is typically defined by a supervising adult to limit the child's access to certain sites. Thus the parameters of the childrens' computer are typically defined by a supervising adult, e.g. parent, guardian, teacher, etc., and a child user.

The invention also provides a method and means for preventing unauthorized copying of content. This allows any content, such as music or video clips, to be made available to a particular user through streaming or the distribution of CD's or any other means, without the fear that the content will be copied or distributed in an unauthorized manner. The user machine and the content are enabled with code that allows only the enabled machine to consume the content. Subsequent unauthorized distribution involves a distribution of the enabled code, which determines whether the new machine is enabled for the particular content and invokes predefined rules in the case of a non enabled device. These rules may include playing part of the content and then requiring billing information from the user in order to acquire the right to continue playing the content. The rules may also include instructions for invoking certain web sites or additional content on the CD or any other source. In order to dissuade a user from making illegal copies of the content once his/her machine is enabled, the invention further inserts the consumer's digital signature or identifier into the content when the content is consumed. This allows the consumer to be uniquely identified from any copy of the content.

According to the invention there is provided a method of providing user specific digital content from at least one first machine over a network to a user on a second machine, comprising verifying the identity of the user, and presenting user specific digital content to the user based on previously received user information. The user information typically includes demographic information about the user, and optionally includes one or more of user interest information and user preference information, and is used in determining the type of content and the manner of presentation of the content. The method may further include obtaining machine information about the second machine, and network connection information regarding network bandwidth, wherein the step of presenting the user specific digital content, takes into account both the user information and the machine and possibly the bandwidth information. The user may be presented with the facility for providing feedback, such as rating information about the digital content that is available for presentation to the user, new web-site information, and new user information. The digital content may include one or more of predetermined web sites, and digital files. Preferably, the method provides the user with the ability to block advertising on a web site or have it replaced with alternative advertising. The demographic information may include age, sex, language preference, and cultural background of the user, and may be supplied by the user or someone acting for the user. The machine information may include hardware and software capabilities of the second machine. The hardware capabilities may include display resolution, sound card availability, sound card parameters, graphics card availability graphics card parameters, and DVD support. The user information may be gathered and made available to any one of a number of devices or machines by means of enabling software, that is made available to the user's device or machine. The enabling software may include a browser, which may include a user interface that prevents a user from typing in a web address.

Typically the connection information is obtained by polling the network connection to the user. As regards the enabling software, it can be supplied in any variety of ways, for example, it can be provided to the user on a portable storage device, or downloaded to the second machine over the network, or shipped with the second machine. At least part of the digital content presented to the user may be downloaded to the user's machine over the network, or on a portable storage device.

Further, according to the invention, there is provided a method of providing user specific digital content, comprising gathering, at a first machine, user information provided by a user using a second machine connected to the first machine, and based on the user information and verification of the identity of the user, providing user specific digital content to the user.

Still further, according to the invention, there is provided a method of presenting digital content to a user on a first machine, comprising providing remote digital content from at least one second machine to the first machine, over a network, providing local digital content on a portable storage medium, and providing means for integrating the remote digital content and the local digital content.

Still further, according to the invention, there is provided a method of restricting access to digital content on a portable storage medium, comprising providing digital content on a portable storage medium, and providing enabling code on the storage medium, wherein the enabling code includes a first set of code for enabling an intelligent device, a second set of code for enabling the digital content, and identifying means for identifying an enabled device, wherein the enabling of the intelligent device and of the digital content includes the implementation of a protocol for communicating between the intelligent device and the portable storage medium.

Still further, according to the invention, there is provided a method of making digital content available to a user, comprising providing digital content on a portable storage medium, and providing enabling code on the storage medium which defines rules for playing the content, wherein the enabling code includes a first set of code for enabling an intelligent device, a second set of code for enabling the digital content, and identifying means for identifying an enabled device, wherein the enabling of the intelligent device and of the digital content includes the implementation of a protocol for communicating between the intelligent device and the portable storage medium.

Still further, according to the invention, there is provided a method of securing digital content, comprising associating enabling code with the digital content, wherein the enabling code defines rules for playing the content on an enabled machine, and enabling a machine to play the content according to the rules, wherein the enabling code defines a communication protocol for communicating the rules and the digital content.

Still further, according to the invention, there is provided a method of controlling the rendering of digital content communicated to an intelligent device, comprising providing digital content and enabling code to an enabled intelligent device, wherein the enabling code includes a protocol for communicating with the enabled device, and code for verifying the identity of a user of the enabled device. Preferably, the enabled device includes a user interface that excludes a Web address entry location.

Still further, according to the invention, there is provided a method of communicating digital content from a first device to a second device, comprising gathering user demographics information about the user of the second device, verifying the identity of the user, and transmitting digital content from the first device to the second device, wherein the digital content is tailored according to the gathered information. The feedback information may include interacting activities between the user and the content, and the gathering of feedback information may include monitoring the number of times the content is listened to or viewed. The tailoring of the content may include denying access to at least part of the content, or denying access to the content after a predefined number of times. The feedback information may include billing information. Furthermore, the second source may be a storage device that is readable by the second device, or may be a third device connected to the second device through a network.

Still further, according to the invention, there is provided a method of conforming an electronically controlled environment to a user's specifications, comprising downloading user information to a controller of the electronically controlled environment from a portable device, wherein the user information includes user preferences.

Still further, according to the invention, there is provided a file format comprising content or pointers to content, and rules for consuming the content by a user, wherein the rules are stored in conjunction with the content or pointers, and wherein the rules include software code for verifying the identity of the user. The file format is typically only accessible by an enabled device that has been enabled to communicate according to a predefined protocol.

Still further, according to the invention, there is provided a file format system comprising content or pointers to content, wherein the content is stored according to at least one file format, and a protocol, wherein the protocol includes rules for accessing the content.

Still further, according to the invention, there is provided a method of obtaining digital content at a first device from at least one second device, comprising providing a facility for exchanging data between the first device and the at least one second device, wherein data from the first device includes user identifying information about the user of the first device, and presenting digital content to the first device based on data received from the first device, wherein the user determines what data to provide to a particular at least one second device. The nature of the content and the manner of presentation may be adjusted depending on the data received from the first device. The data received from the first device may include demographic information about the user, and in the absence of the user supplying demographic information, the second device may present the content according to predetermined default parameters.

### BRIEF DESCRIPTION OF THE DRAWINGS

FIG. 1 is a representation of a general client-server arrangement;

FIG. 2 shows one embodiment of a browser user interface of the invention;

FIG. 3 shows one embodiment of a user identification method of the invention;

FIG. 4 shows one embodiment of a secondary screen invoked by clicking on one of the options of the browser user interface of FIG. 2;

FIG. 5 shows one embodiment of another secondary screen invoked by clicking on one of the options of the browser user interface of FIG. 2;

FIG. 6 shows another embodiment of a browser user interface of the invention;

FIG. 7 shows the effect of clicking a drop down menu on the browser user interface of FIG. 6;

FIG. 8 shows the effect of entering a search term in a search term window on the browser user interface of FIG. 6;

FIG. 9 shows one pop-up window invoked by selecting a Settings option on the browser user interface of FIG. 6;

FIG. 10 shows another pop-up window invoked under the Settings option on the browser user interface of FIG. 6 by selecting a Kid's Protocol subcategory;

FIG. 11 shows yet another pop-up window invoked under the Settings option on the browser user interface of FIG. 6 by selecting a Schedule subcategory;

FIG. 12 shows yet another pop-up window invoked under the Settings option on the browser user interface of FIG. 6 by selecting the Add Family Member tab;

FIG. 13 is a flow chart showing one example of enabling an intelligent device, and FIG. 14 is a flow chart defining the steps involved in providing enabled content.

### DETAILED DESCRIPTION OF THE INVENTION

The present invention deals with a method and system of providing digital content in a manner that is peculiar to the recipient and takes into account both the interests of the content recipient and the content provider. This allows the interests of the participants to be protected. By allowing the user to specify his/her preferences, it also allows a user to define his/her environment to achieve the user's unique desires regarding his/her electronically controlled environment. The invention thus finds numerous applications, some of which will be discussed in greater detail below. In order to illustrate the underlying concepts of the invention, one embodiment of the invention, involving a simple client-server environment, will be considered.

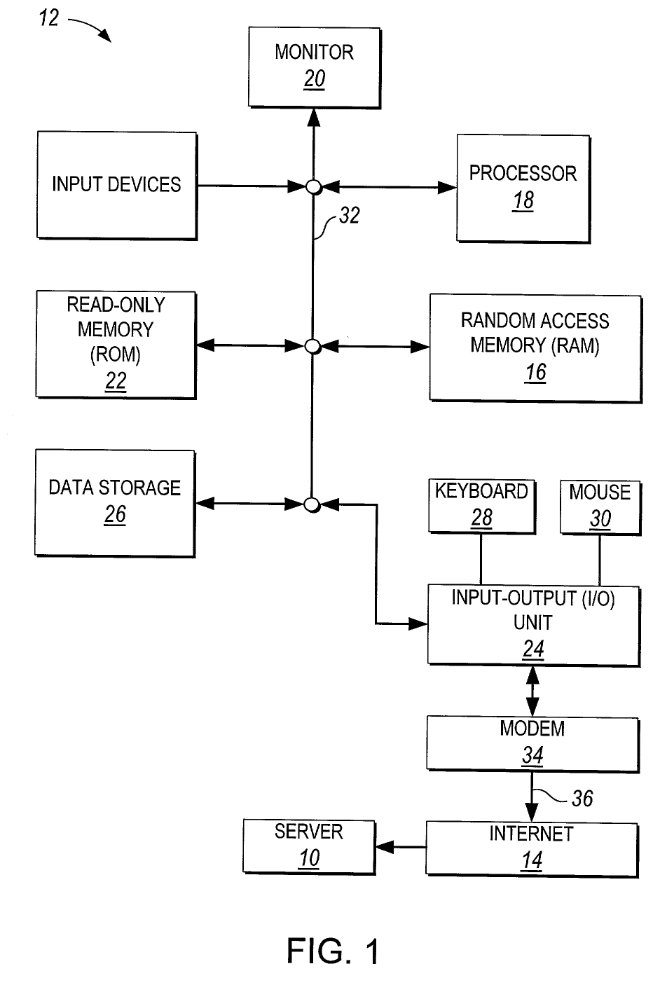

FIG. 1 shows a server machine 10 connected to a client machine 12 through a network 14 such as the internet. The client machine 12 includes a Random Access Memory (RAM) 16 into which the software program for implementing the functionality of the invention is loaded, a processor 18 for executing the program, a visual display unit or monitor 20 for providing a visual display of information, a Read Only Memory (ROM) 22 for storing firmware, an input-output (I/O) unit 24 for connection to a printer, modem, etc., and a mass data storage 26 which can be one or more suitable storage devices such as a hard magnetic disk drive, a removable (floppy) disk drive, and optical (CD-ROM) drive, etc. The program which implements the invention may be stored in the storage 26, and modules of the program loaded into the RAM 16 for execution as required. User access to the machine 12 is provided by input units comprising an alphanumeric keyboard 28 and a pointing device such as a mouse 30. The elements of the machine 12 are interconnected by a bus 32.

While the client machine 12 of this embodiment is depicted as a PC, it will be appreciated that this is just one embodiment of a client machine 12. The client machine 12 could equally well take the form of a lap-top or palm-top machine or an information appliance geared for accessing the Web. As shown in FIG. 1, the client machine 12 is connected to the server 10 via a modem 34 and telephone line 36 forming part of a network 14, in this case the Internet. It will be appreciated that the machines 10, 12 can be connected by any network arrangement, which can include any combination of: coaxial cable connections, optical fiber connections or even wireless connections, such as Bluetooth.

As will become clearer from the discussion below, this is only one embodiment of the invention. The application of the invention is, however, broad enough to cover not only client-server or other networked arrangements but also peer-to-peer communications, standalone systems, and, in fact, any intelligent device that can be enabled with enabling code in accordance with the invention. As is discussed in greater detail below, the invention includes enabling any intelligent appliance which is designed to communicate information. The former may be a standalone or networked PC with capabilities for playing a CD-ROM. The latter may be a smart card or key ring device carrying personalized information, to facilitate personalizing a user's environment such as his or her office, motor vehicle, personal computer, etc. This is achieved by transferring the information inherent in the device to a controller that controls the user's environment.

Considering again the client-server arrangement of FIG. 1, the computer software program, also referred to as the enabling software or the enabling code, which implements the functionality of the present invention on the user's machine, can be loaded onto the client 12. This can be achieved by any one of a number of methods. In this embodiment, the program is supplied on an optical CD-ROM disk. It is loaded into the client machine 12 and stored on the hard drive 26 by running a setup program. It is, however, within the scope of the invention to provide the program, which, for convenience will be referred to as System X, on any other computer readable medium. For instance, it can be supplied on one or more magnetic elements such as floppy disks, or stored in a ROM or other computer memory element. It can be provided on a portable memory device, e.g., a disk on a keyring where information is transferred via a physical connector or wireless means, e.g., Bluetooth. It could also be retained on the server machine 10 or on one or more other storage devices external to the client 12 and server 10, and supplied to the client 12 over the network 14, for example as an Active X component or Java Applet. The enabled device, in this case the client 12, communicates with another device or content, which, insofar as the other device or content is enabled, will interact with the client to provide content according to parameters defined by the enabled content or the other device.

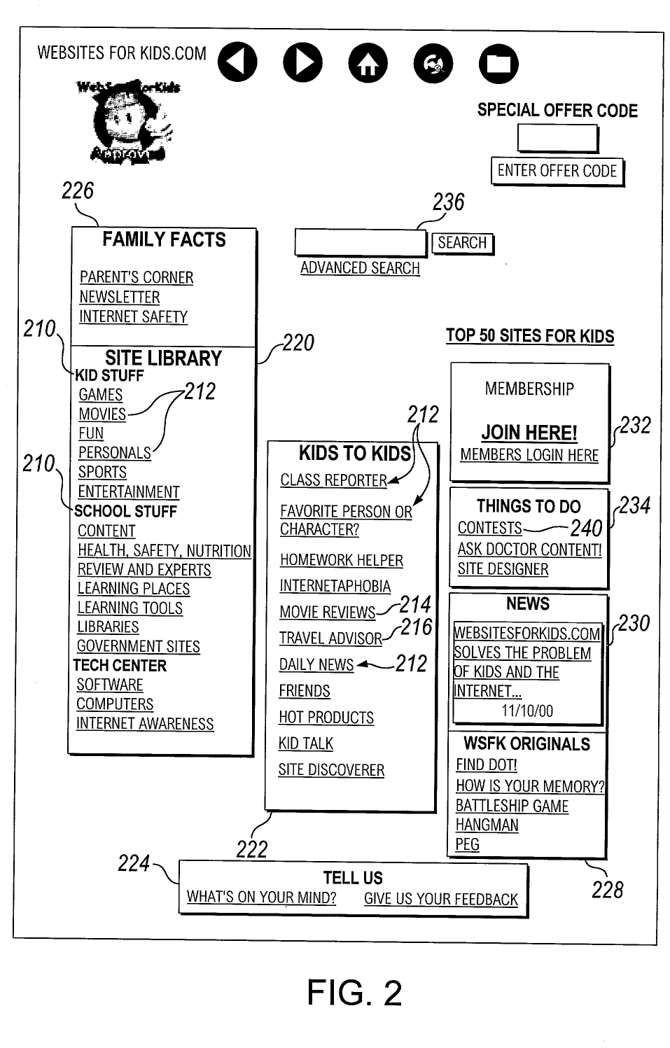

The functionality of the present invention will be described first, with reference to FIGS. 2 to 8. Thereafter, the installation and the internal structure and operation of the software will be discussed in detail.

### Functionality

In the case of certain user groups, such as children, it may be in the interest of the user or someone acting for the user, for example, a child's parent or legal guardian, that the user only have access to certain pre-approved or supported web sites or material. The present invention achieves this by providing a browser with a user interface such as the one depicted in FIG. 2, which shows a network browsing screen of a browser user interface. The browsing screen specifically does not include a web address entry location. Instead, a user is restricted in his/her choices by being limited to selecting from pre-defined categories 210, which, in turn, may each provide further sub-choices 212 from a list of supported sites. In this embodiment, the browser includes drop down menus or other selection facilities to limit a child's access to only pre-approved sites. Clearly such a browsing screen, which avoids the need to type in web addresses, would be useful in other applications as well, especially in small web access appliances having limited or laborious user access functionality such as touch sensitive screens relying on character recognition software.

As part of the enablement of the device, in this case the client computer, information is requested from the user's guardian, that will allow the user to be identified. Thus, the enabled device will include an implementation of a protocol and information identifying a particular user. One of the features of the protocol is the ability to exchange information and adjust the content that is consumable, based on such information. Thus it acts as a broker for communicating between two devices or processes. For example, demographic information can be provided by a consumer, or delivery preferences, personal preferences, content preferences, or financial information, to name but a few.

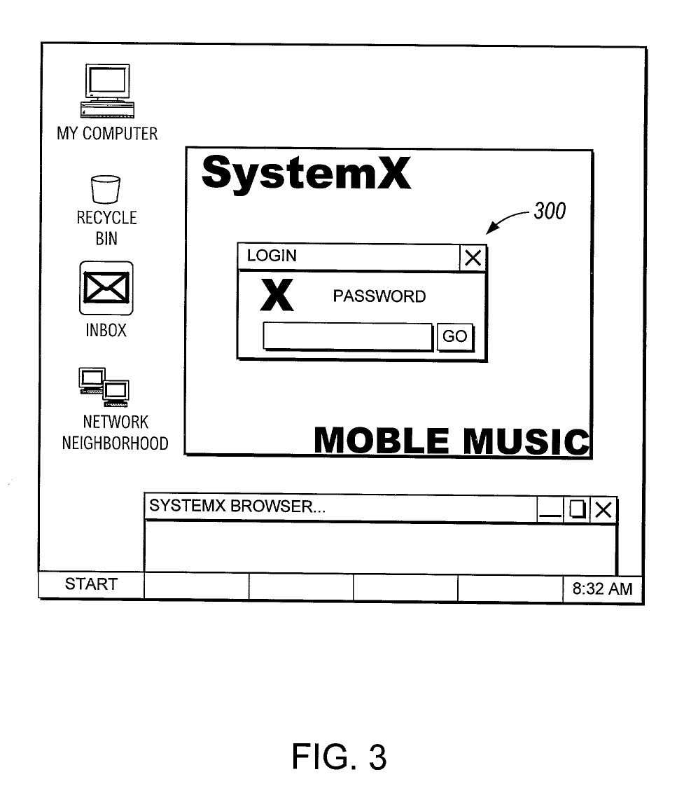

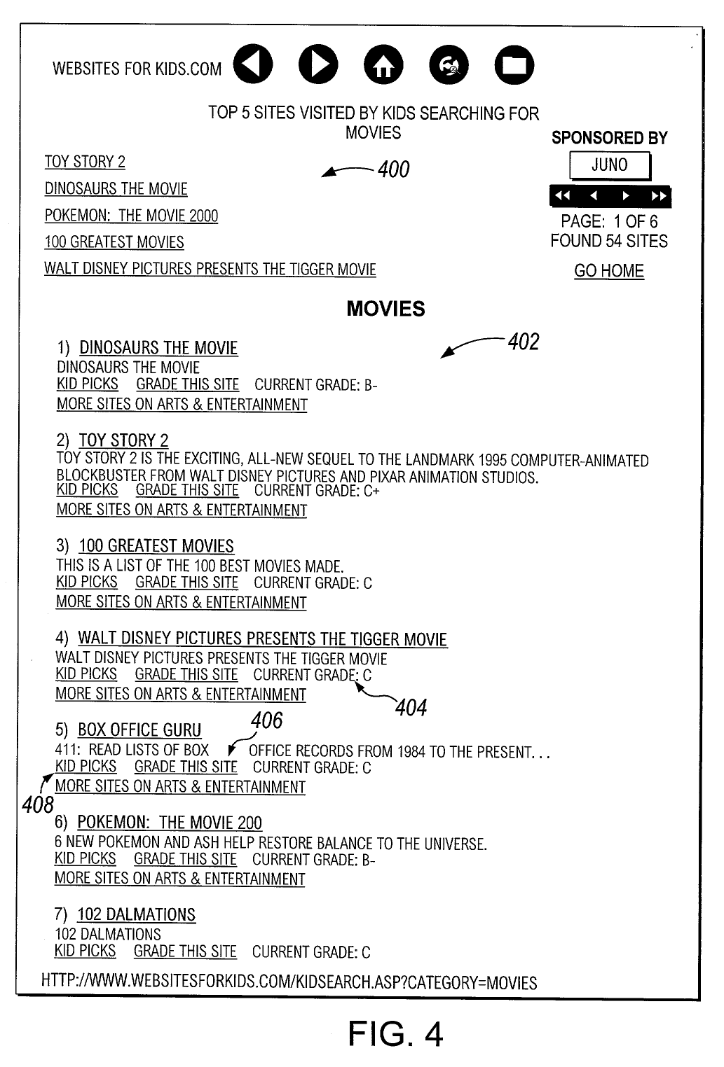

Once the user device has been enabled, it will, prior to a communication session, request that the user identify him/herself to verify the identity of the user. These may take different levels of identity or authentication, e.g., simple user identification by means of a password, credit card information with or without additional verifying information, third party verification, where the third party acts as intermediary, biometric verification such as finger prints or retinal scans, voice proofs, etc. Thus, in one embodiment, the user identification simply takes the form of a password as depicted by the request box 300 in FIG. 3. Referring again to FIG. 2, the user may, for example, select Movie Reviews 214 from the sub-categories 212, by clicking on Movie Reviews 214. This brings up a list of movie sites 400 (FIG. 4) most commonly visited by kids and the most popular movies 402 for the user's age group. It also provides kids with the facility to view the grade value associated with a movie (Current Grade button 404) and to Grade the site themselves (button 406). It also allows other sites which were accessed by kids in that age group, to be accessed (Kids Pick 408).

From the layout of the search page (FIG.2) which is also the home page in this embodiment, it will be noted that the search categories in this embodiment have been grouped to distinguish between information supplied by content providers 220, interactive information 222 as provided by the kids amongst themselves, feedback information 224 provided to content and service providers, legal and parental information 226, games 228, information about the site 230, a log in site 232 to verify the identity of the particular user, miscellaneous areas of interest 234, and a search term entry field 236 linked to a search engine.

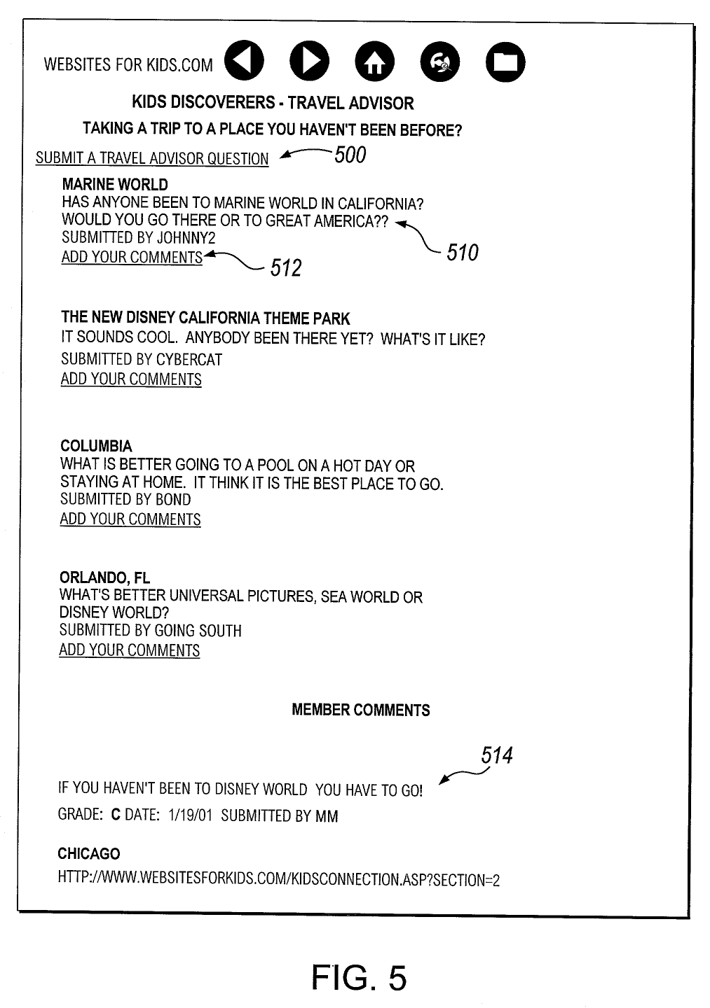

FIG. 5 shows a sub-page, which was accessed by clicking on Travel Advisor 216 (FIG. 2). It includes a hyperlink 500 that brings up a page (not shown) with data entry fields allowing users to submit requests for information feedback on travel sites. These requests are posted on the Travel Advisor page (FIG. 5) as shown. For example, the information request 510 submitted by a kid with the user name Johnny 2, seeks information on Marine World. Responses can be submitted by clicking on the Add your comments link 512. The responses 514 are posted at the bottom of the page.

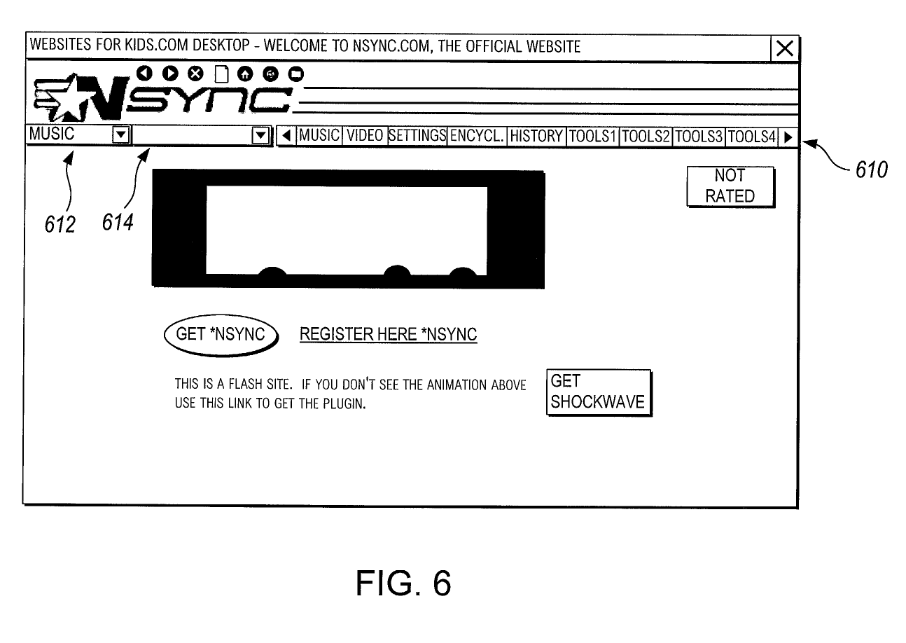

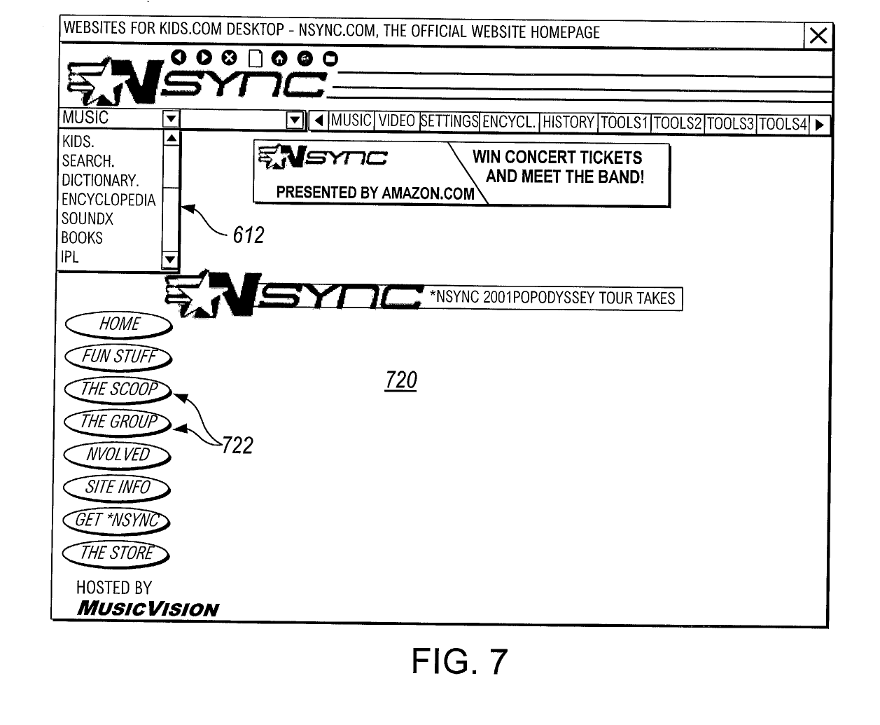

It will be appreciated that the layout and type of information presented in FIGS. 2-5 are examples of one embodiment only. Different categories and layouts could equally well be implemented. Computers could also be enabled for specific types of information or applications. The invention also envisages using the browser user interface page as an advertising medium. For instance, a particular entity may license the rights to distribute the browser, and may make the browser available with its logo or other features on the browser home page. For example, FIG. 6 shows a NSYNC browser page with NSYNC's logo and search categories 610. It also includes a drop down menu 612 and search term entry field 614. The drop down menu 612 is shown in FIG. 7 which also shows a subsequent page 720 in the lower portion of the display, with additional hyperlink subcategories 722.

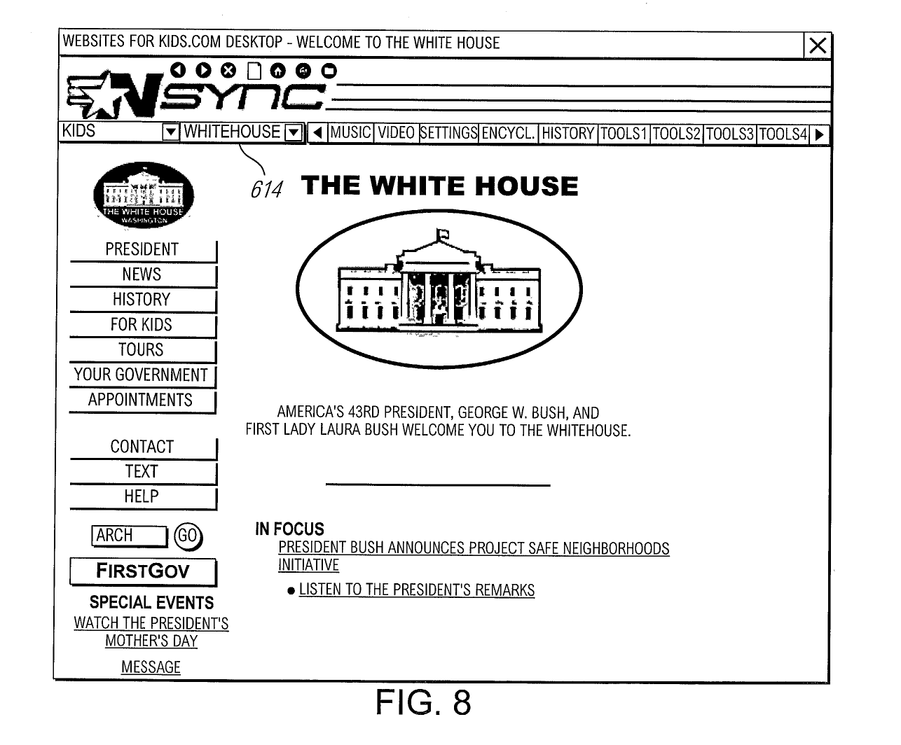

FIG. 8, in turn, shows the result of entering the term “whitehouse” in the search term entry field 614. Again, only approved sites are made available according to the negotiations performed by the protocol, taking into account the user information that was originally gathered.

### Installation

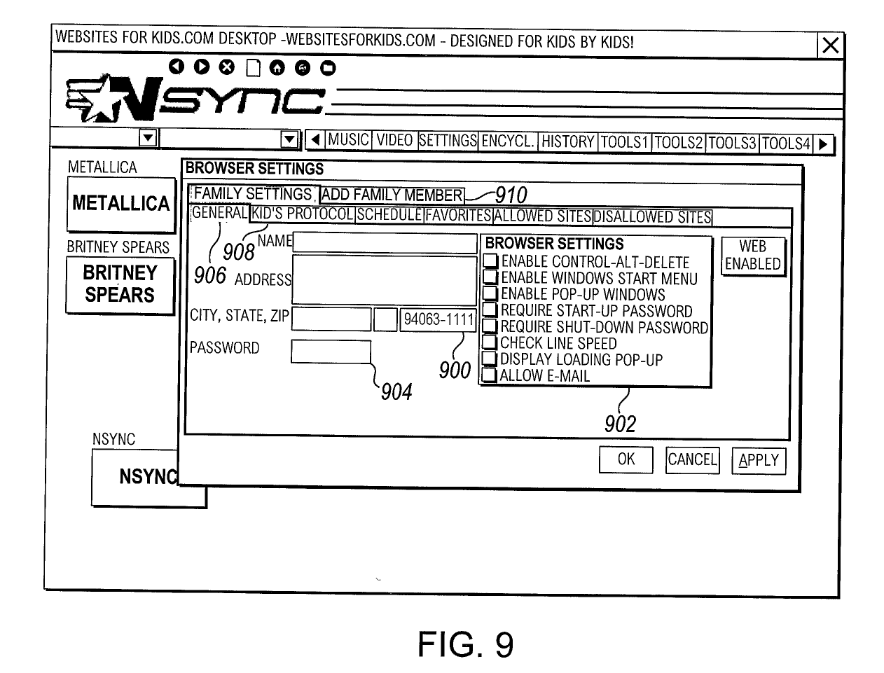

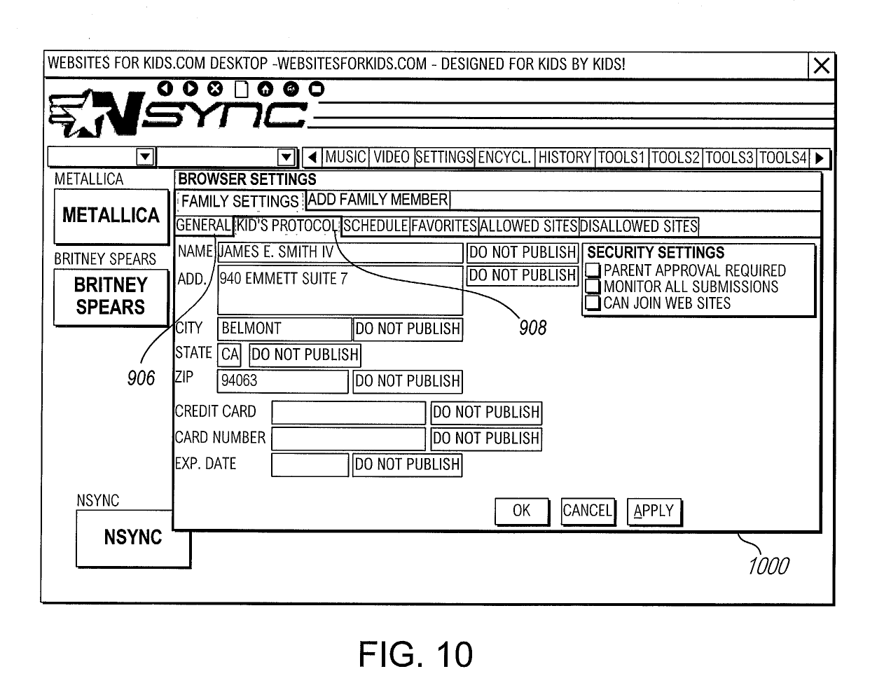

In order to originally gather the user information, the installation of the program invokes an information gathering screen. In a kids scenario, parental consent may be required, which may take the form of different levels of consent, defining what content the child may receive or disclose. As shown in FIGS. 9 and 10 parental information is gathered. FIG. 9 shows a typical data entry screen for supplying parental/guardian information in data entry locations 900, and by specifying characteristics that are to be adopted by the device by marking check boxes 902 which define enablement features. In this embodiment the enablement features include the ability not to enable the Control-Alt-Delete feature to avoid a child inadvertently rebooting the computer; not to enable the Windows Start Menu; not to enable Pop-up windows, to inhibit unwanted advertising; enable or disable the need for a Start-up and Shut-down password; enable checking of the line speed; enable or disable the display of a loading pop-up (a loading pop-up may be undesirable where sites are downloaded in rapid succession), and the ability to enable or disable e-mail. These parameters are protected by requiring a password in block 904. In another embodiment, instead of disabling advertising altogether, the user or the user's guardian may be given the option of selecting a certain type of advertising that is pertinent to the user's interests, or allowing the advertising to be dynamically adjusted based on the user's information, in the same way that other content is tailored to the user's information.

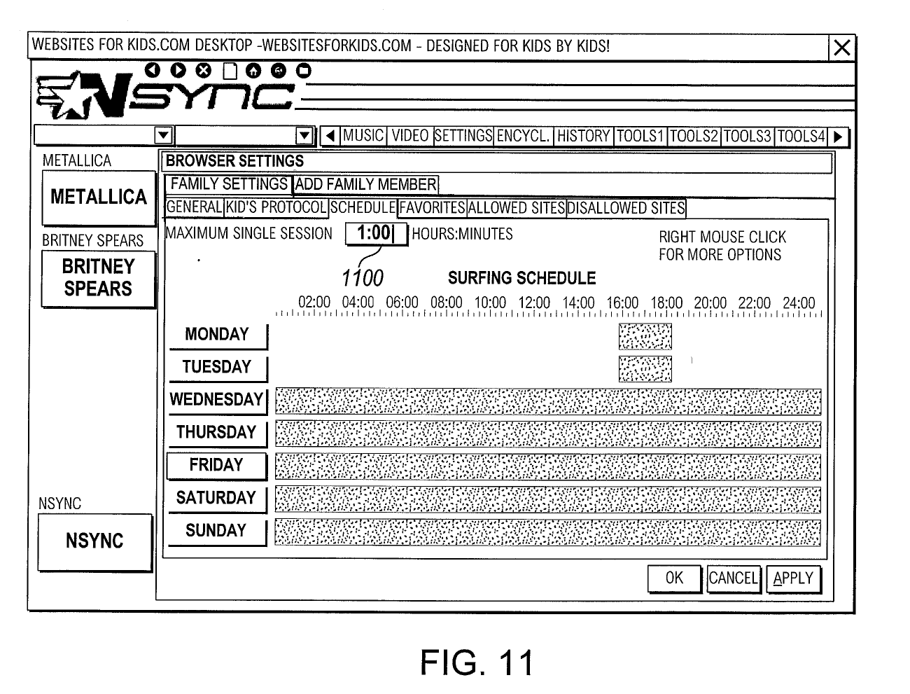

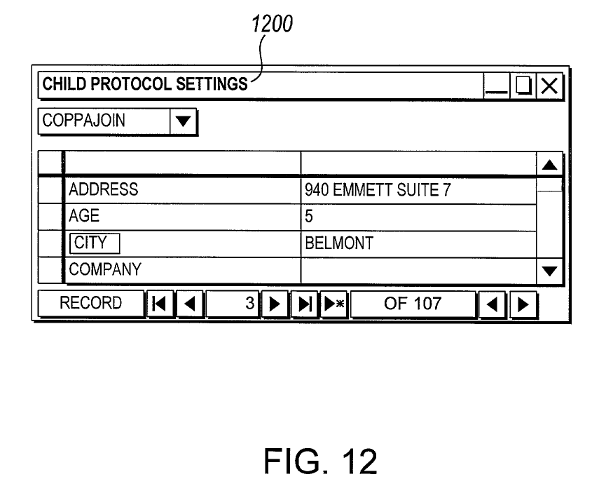

FIG. 10 shows a parental confirmation screen 1000 for entering the confirmation information such as credit card information. In this embodiment, the parent can specify what information may be published. As is clear from the tabs visible in FIGS. 9 and 10, the Family Settings option allows not only the General information tab 906 or the Kid's Protocol tab 908 to be selected, as shown in FIGS. 9 and 10, but other tabs, including a Schedule tab which brings up a scheduling screen as shown in FIG. 11 to define a weekly schedule during which a child may access the computer. The scheduling screen also allows the maximum time that a child may use the computer in a certain session, to be specified, as provided for by the data entry location 1100. FIGS. 9-11 also include tabs for specifying favorite sites (Favorites), Allowed Sites, and Disallowed Sites for a particular child, allowing a parent to override a content provider's decision. Once the parent has customized the computer for the child user and verified his/her own identity, family members may be added using the Add Family Member tag which brings up a screen for selecting a type of family member, e.g., adult, teenager, or child. Each such selection allows user specifics to be entered as shown in FIG. 12. The drop-down menu 1200 allows various aspects to be addressed, such as COPPAJoin information (as shown). COPPAJoin brings up a window that includes both information entry locations for demographic data as well as some user preference information. The drop-down menu 1200 also includes other aspects, e.g., other user preferences, additional user demographics, user interests, user specified machine characteristics, etc.

Typically user information may include user demographics such as the user's age, sex, language, and cultural background. In this embodiment, user interest information and user preference information are supplied on separate screens. For example, the user is prompted to elaborate on his/her interests in sports, music, outdoor activities and other interests, thereby defining the user's interest information. It also allows the user to specify preferences regarding type of content, e.g., text only, still images, sound, or video.

As discussed above, as part of the initial set-up procedure, the user or a person acting for the user, such as a parent or guardian of a child, is presented with the choice of activating of deactivating all advertising appearing on the child's screen. Another embodiment could provide the option for the user or the person acting for the user to select alternative advertising which will ensure that the advertising appearing on the user's screen is appropriate or relevant to the user.

As is discussed in greater detail below, the present embodiment allows the user to select between the available screens to add, update or edit information. In the present embodiment, in which the contemplated user is a child, the information gathering screen comprises two separate screens: one for defining, among other things, user demographics (FIG. 12), and one for specifying user interests (not shown). The former screen, in this embodiment, can be accessed only with the necessary parental authorization and can be implemented in different ways, to require any one of a number of known identity checking facilities such as credit card information (screen 1000) or signature verification. Signature verification may take place through the use of conventional mail or using electronic transmission and character recognition technology. As technology continues to develop, other forms of verification may become viable such as thumb scan or retinal scan confirmation.

In response to the information gathered from the user, the server will then respond to user requests for content in a fashion that will take into account the user's demographics, interests, and preferences. Thus, in order to enhance the user experience, the invention envisages molding not only the types of content but also the manner in which they are presented, to the user's specific needs based on one or more of the user's demographic, preference, and interest information. For example, in the case of a three year old child, the sites made available to the child will be quite different to those for a ten year old, or eighteen year old. Also, the manner in which the content is presented will differ. In the case of the three year old who, in all probability, cannot read, content will be presented in the form of images, graphics, video or sound files. Thus the protocol implemented by the enabled devices will serve to adjust the look and feel of the browsing screen, and will, for example, change the background of the screen to make it more suitable to the age, sex, and cultural background of the child.

As mentioned above, the decision as to what content is suitable and should be made available to the particular user will depend on the user information that was supplied. The age, sex, and geographic location of the user are used as part of this decision making process. Thus, for example, the list of sites that are made available to the user may vary depending on the user's age. Similarly, language preference information may be used to list the sites in order of language. Thus, a user who indicates Spanish as a preference may be provided with Spanish sites listed first. Similarly, in the case of a teenager who has indicated an interest in football, NFL related sites and profiles on football players may be identified in the most prominent group of available sites. This embodiment of the invention also includes a facility for providing the user with rating information on the various sites that are available. The service provider may provide this information based on feedback from users. The ratings can also be based on the number of hits or downloads a site experiences.

In a preferred embodiment, not only user information is considered in presenting information, but also client machine capabilities and the nature of the network connection. Thus, as part of the decision making process of which sites to make available to the user and the manner in which the information is to be presented, a preferred embodiment will also consider the hardware capabilities, such as graphics card and sound card availability and parameters of the card, as well as the software available on the client machine. For example, demographic information may indicate that the user is a child below reading age. In such a case text may be replaced by sound files, but only insofar as the client machine has been determined to have a sound card and speakers. Similarly, images and even video clips may be included, provided that the client machine has a graphics card and the bandwidth that is available makes this a practical option. Thus a user with a fast Internet connection such as cable or DSL may be presented with more data intensive content like video, while another user, with a slow dial-up connection, will be presented with a less data intensive solution such as text. The bandwidth of the network connection can be determined in any known way such as the approach adopted by Bandwidth.com in which the server polls the data transfer rate over the network 14 to the client machine 12 by sending a known length portion of data and measuring the download time.

In one embodiment, the user may be presented with a choice in the form of an options list from which to select a data format, insofar as the server identifies the availability of different forms of data. Thus the user may decide to wait for video content to be downloaded even where his/her machine has a slow dial-up connection. Similarly, a user may decide to opt for quick downloads by foregoing some of the data rich content. Thus, a user can set the range of machine/device levels or characteristics. The user in this embodiment controls all delivery settings. For example, the user could specify, no sound, even if a sound card was present.

The invention thus provides a facility for two devices to exchange data and allow the device supplying the digital content to adjust the content and manner of presentation depending on the data received from the other device. Similarly the user at the other device can decide what data he/she is willing to provide to the device supplying the content. Thus, both the user or consumer of the content, and the supplier of the content remain in control over what data/content is transmitted to the other. A user may be willing to supply certain data to one content supplier, but not to another. It will be appreciated that, although the above scenario speaks of two devices, more than two physical devices or machines may be involved. For example, the content may be stored at a various sources.

The enabling code may also include additional user interactive features including providing the user with a commentary screen to allow the user to provide feedback. The feedback may be categorized. For example it can include feedback regarding potential new users, and identifying new web sites which the user would like to see included in the list of approved sites. An example of such commentary feedback was shown in FIG. 4 for feedback on movies. New sites may, thus, be added to the list of supported sites, based on recommendations submitted by users. In a preferred embodiment, a base screen or home page is provided which allows the user to select between the various screens. In the present embodiment, the browsing screen shown of FIG. 2, also serves as the base screen or home page. In this embodiment, the user may select the commentary screen from the base screen by clicking on the “Give us your feedback” link 224 in order to provide feedback about new sites, or, in another embodiment, the base screen may include a “new site” tag, for bringing up a commentary screen directly. Similarly, users may submit details of new members, for example, by using a “new member” tag . It will be appreciated that “new site” and “new member” tags could, instead, bring up separate screens specifically designed for entry of new Web site addresses for proposed inclusion in the list of supported sites, and for entry of new members, respectively. It is envisaged that, as an incentive to submit new sites and members, prizes can be awarded to users on a merit basis. Winners are preferably named in a winners list which, in the embodiment of FIG. 2 is accessed through the Contest tag 240 or, in another embodiment, a separate members of the week tag (not shown). It will be appreciated that, in the case of an arrangement directed at children, new proposed members will typically also be children. The invention, further, serves as a vehicle to induce content suppliers to register as authorized content suppliers, since it assures exposure to a defined audience, and thus provides for targeted advertising. For this reason adult authorization has to be obtained as part of the process when a user submits new member information.

It will be appreciated that the server machine 10 and network 14 are shown by way of example only and need not be a single server machine or a single network wire. The invention could be implemented on numerous server machines, and the network 14 may consist of many pathways and connections, as in the case of the Internet. Also, while particular applications were discussed above, the invention is broad enough to cover many other applications.

The present invention, for instance, provides a solution to the problem faced by the music industry, of preventing unauthorized copying and distribution of copyrighted music. It also provides a vehicle to enhancing the user experience. For example, the present invention contemplates not only structuring requested content to the user's needs but also enhancing the user's experience by causing the user's machine to perform certain tasks in response to instructions incorporated in the enabled content. In one implementation, a music CD can be implemented as a hybrid CD with audio content in the form of WAV files, which may be played on a dumb device, such as a boombox, and additional content in the form of enabled content that can be played only on an enabled machine. The enabled content may include music files or pointers to music files. It may also include other content such as a video clip or instructions to download a web site. Typically therefore, the outer tracks of the CD will support the music content. Furthermore, the CD will include tracks supporting enabling code. The enabling code performs the function of enabling an intelligent device, and of associating enabling code with all or part of the content. Thus, in the case of an intelligent device, the enabled content will only be playable once the device is itself enabled. The task of enabling the intelligent device, such as a PC, involves providing the intelligent device with an implementation of a communication protocol that allows the device to communicate with the enabling code on the CD to play the enabled content on the CD according to certain rules inherent in the enabling code. The content on the CD, which is accessible by the enabled device, may include not only the audio content that is available to a dumb device, like a regular CD player, but other content, such as video content. Furthermore, the rules inherent in the enabling code may cause the intelligent device to perform additional tasks, such as access a specific web site over the Internet that complements the video content. The web site may for instance provide information about the artist in the video or about upcoming music events in the user's geographic area.

Thus the invention also contemplates rules for pushing additional content to the user's machine, and provides a marketing tool to the CD supplier or to the content supplier. Again, however, the basis for pushing information onto the user's site may be made dependent on feedback provided by the user. For example, in one embodiment, where the CD is to be made available only to certain age groups, it is envisaged that when the CD is installed, one of the rules inherent in the enabling code will require user identification. Thus, again both parties are involved in deciding what information is made available and the form of the content.

It will be appreciated that either one or both of the code and content could be provided to a user's machine over a network and need not be provided on a CD.

Yet another application contemplated by the invention involves the ability of a user to carry his/her user preferences around on a portable device such as a keyring device or smart card. This will allow a user to download his/her preferences to one or more types of intelligent devices to tailor electronic surroundings to the user's needs. For example, controllers can be provided in rental vehicles which will interface with user devices, thereby to allow users to automatically adjust seat, window, and radio channels to the users respective preferences. In another application, a user may carry around his/her personal preference settings for a PC. Thus, a user sitting at a computer may use the portable device to connect to the transport layer and specify user preferences in order to provide his/her personalized desktop. In yet another application, a user may use a portable device to set the lighting, temperature, music, TV, and radio channels in a room. Downloading of the information from the portable device can be by way of a physical or wireless, e.g., Bluetooth, connection. Thus dissimilar enabled devices are able to communicate device/content parameters and/or user preferences to tailor content and environments accordingly. For example, a user may prefer delivery of content in the form of sound as opposed to text. Similarly, a device may not have a sound card, thereby resulting in content being delivered in a form other than sound. Also, the content provider may specify that content may only be played on a particular device.

### Implementation and Internal Structure

In order to implement the present invention, two devices or a device and the content have to be enabled. This may be achieved in any one of a number of ways. For example, an intelligent device such as a PC may be provided with enabling code that is supplied to it on a disk or over a network. Instead the PC may be shipped with the enabling code pre-installed. In the case of a dumb device, such as a boombox or USB hub, a hardware of software layer could be provided that acts as a translator for communicating according to the protocol of the invention and thus allows the dumb device to behave as an enabled device. In the case of the client-server arrangement of FIG. 1, the client machine 12 has to be enabled to communicate with an enabled server 10. The client 12 is enabled by providing it with enabling code, which, in this embodiment, is supplied to the user on a CD or over the network 14, and stored in the storage 26. The enabling code allows the client 12 to communicate according to a specific communication protocol and associates a particular user to a communication session. The content or machine supplying the content is also enabled to permit communication between the client and the content or machine supplying the content, according to the protocol. By defining rules for the exchange of information and/or content, the protocol places the two communicating parties in control of what content is made available and in what format. As discussed above, in the case of a minor, some of the decision making is determined by the parent or guardian, but, nevertheless, the communication is then unique to the particular user as opposed to being generic to the client machine. The rules may differ from one application to the next. For example, in the child protection scenario discussed above, the enabling of the client provides for the request for user information. The supply of such information is determined by the user as the user sees fit, and the resultant presentation of available Web sites to the user is based on the information supplied by the user.

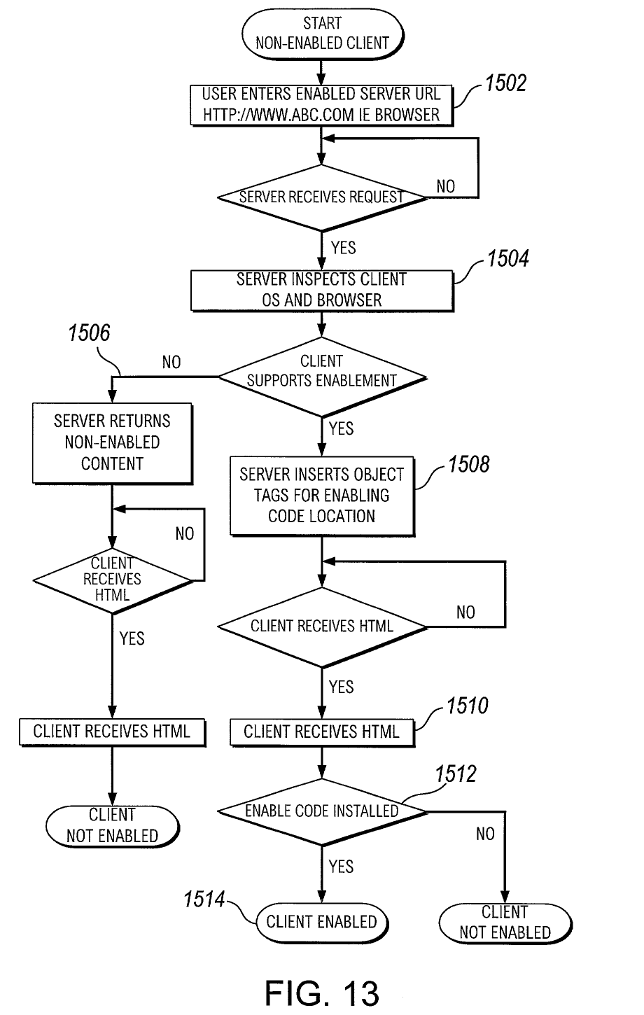

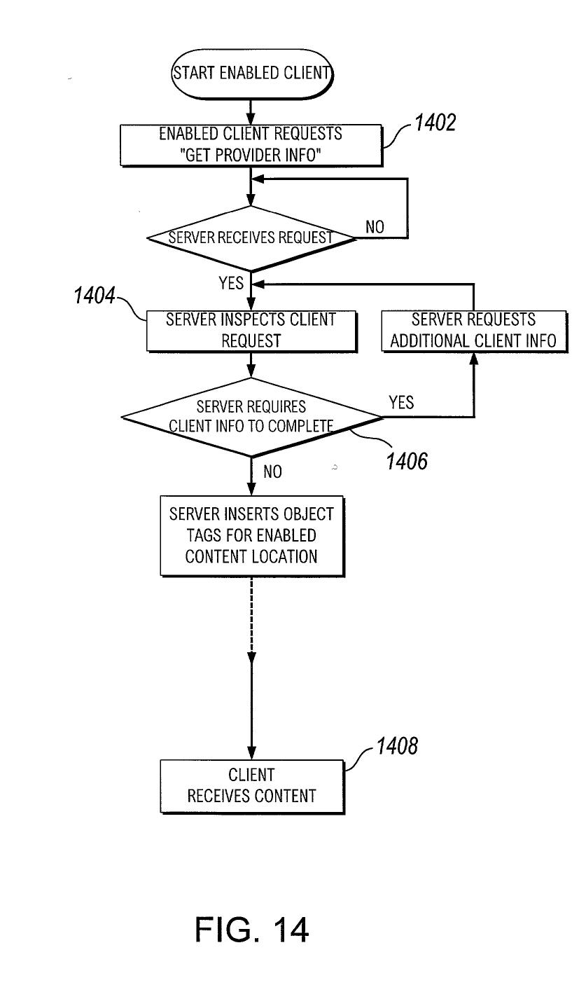

The functional steps involved in enabling a client are shown in FIG. 13. After entering the URL of a web site for an enabled device such as an enabled server or enabled client (step 1302) the protocol inspects the user's machine operating system and browser (step 1304) to determine whether the client supports enablement. If not, non-enabled content will be delivered (branch 1306) using any available communication protocol such as HTTP. If the client supports enablement, the enabling of the client proceeds. The server inserts object tags for the location of the enabling code (step 1308). The installation program sets certain parameters or signatures on the client computer, which will thereafter be recognized to avoid subsequent reinstallation of the installation program. In some situations a single client enablement may support numerous subsequent communications. In other applications, such as the music industry, where different CD's are to be individually uniquely protected, each different CD will include its own unique enabling code. The signatures set by the installation program are typically stored in one or more of the hard drive of the computer, the registries in the case of a windows computer, and windows system files. The installation program stores executable software (which can be defined as the enabling code) and certain files in these locations. The files may, for instance, include a file name and a version number to identify the existence of enabling code and allow the current version to be checked and updated if necessary. Once enabled, the newly enabled machine (in this case the client machine) will communicate with the server according to the protocol of the invention. Thus, any request for content will be received by the content supplier (in this case the server) and processed according to the protocol. User information will be requested, or if previously supplied as part of the enabling process, will be used to determine what content to make available and in what format. The invention thus also defines a unique file format in which content or pointers to content are stored in conjunction with rules for consuming the content. This file format is only accessible through the use of the protocol of the invention which is embodied in the rules of the enabling code and imparted to a device or machine through the device enabling steps discussed in more detail below. Broadly viewed, the steps involved in enabling a device for a child user and providing targeted content can be summarized by the following steps:

determining whether a machine is enabled, and, if not, determining whether it is capable of being enabled, and, if so, providing enabling code to the machine,

generating an information gathering screen for a browser user interface to allow the user or the user's guardian to enter user demographic information (as illustrated in FIG. 12),

transmitting this information to the server 10 or any other defined location,

generating an information gathering screen to allow a user to provide user preference or user interest information,

transmitting this information to the server 10 or any other defined location,

generating a browsing screen to allow the user to brows a predefined set of web sites.

These steps may comprise separate steps of lumped together in a single communication. For instance, the information gathering may form part of the enablement of the machine. Thus, providing the enabling code to a client machine may include requests for certain user information, thereby providing a server driven process. Instead, the client may be enabled, whereafter, a request for certain content will invoke a request for user information. Thus, the user information gathering process may be associated with the content itself. Furthermore, the communication of user information need not be between one machine and another, but could be a communication taking place on one machine based on communications with enabled content with its inherent rules for consumption. Thus the protocol provides for multiple requests and single or compound commands. Information can be requested all at once, in groups, or can be requested individually. Responses may also flow in groups or individually. Either side may terminate the communication at will.

It will be noted that the parent's or guardian's assistance was invoked and that the gathering of the demographic details required parental consent. This is necessitated by certain legal provisions such as the Children's Online Privacy Protection Act (COPPA) which restricts the gathering of child information for kids below the age of 13, by requiring parental consent.

In this application the enabling code includes a browser or code to be used in conjunction with an existing browser to ensure that the user interface of the browser, does not include a web address entry location. This was discussed in detail above with reference to FIG. 2. Once the user information is gathered, it is stored on the client or the server or any other location, and is associated with a user identifier such as a password or thumb scan verification. Thereafter, whenever the user logs on as the authorized user, the rendering code, which could be stored on a server, presents a browsing screen, geared to the user's profile. It also invokes the user information in making content available. Thus, only web sites appropriate for the user are made available based on a protocol that exchanges the various parameters and determines what content to make available and in what form

Thus, inherent in the process of enabling the client machine is the provision of the means for communicating between two devices according to a defined protocol and the association of a particular user with a communication scenario. The association with a particular user involves extracting user information from the user and providing for a password or other form of user identification. Once user information has been gathered from the user, digital content is presented to the user based on whatever user information the user chooses to supply. However, until the user's identity is sufficiently known, the protocol will define the user as a child. Thus, while one feature of the protocol is to allow the user's age to be specified, the default in this embodiment, is a child of age 3.

FIG. 14 shows the negotiation steps between two enabled devices. In step 1402 the enabled client requests information from an information provider by clicking on a hypertag of an available site. Once a server receives a request for content, it inspects the request (step 1404) and determines whether it requires additional information (step 1406) from the client, e.g., credit card information, before supplying the enabled content (step 1408). In the case where the client requests a web page/content, the client may only request the location of the content and provide no user information. Alternatively, the client may specify, in the original request, the user information, thus potentially avoiding further requests for information by the server machine. Thus, in one embodiment, the server can provide the requested content, or, in another embodiment, it can request additional information from the client. If the client responds to the request, this, in and of itself, would indicated enablement of the client. Similarly, the request by the server to the client would demonstrate to the client that the server is enabled. In either case, the server would identify the client as having been enabled.

It will be appreciated that various applications of the invention may provide for different approaches in enabling a machine. For example, in the scenario where children are to be protected from undesirable content on the Internet, the user's device can be enabled in any one of a number of ways. For example, it can be installed on the user's machine by means of a compact disk or floppy disk. It can also be downloaded from a server or any other device over a network such as the Internet, or a wireless connection, e.g. a radio communication link, infra red link, blue tooth connection, etc. One commonly known approach for implementing software over a network is by way of an Active X component or Java Applet.

While the term client and server were used in the embodiment of FIG. 1, the invention envisions many other scenarios including peer-to-peer communications. Thus any two clients could initiate communications with each other and exchange digital content files.

In order to appreciate the broad scope of the invention, it helps to consider a different implementation of the invention. For example, in the music industry scenario the two devices may comprise a PC and a compact disc. The compact disc serves as the vehicle for the content and for providing enabling code to the PC. Thus the disc, which in this example is a hybrid CD, includes content, code for enabling the PC, and code for enabling some or all of the content by associating rules with the content that will define how and under what circumstances the content can be played. The installation script will determine whether the PC is enabled for the particular CD. If not, it may play part (i.e., a preview) or none of the content. The enabled content may thus include a preview portion that can be consumed on a non-enabled machine. In a preferred embodiment, the enabled content will also include executable code for enabling the client machine. Once enabled, the user will be prompted for information in order to consume the enabled content. Typically, the user will be asked for billing information. Once this information is provided, the rules allow the content to be consumed and, as discussed above, may cause the PC to perform additional functions such as download a related Web site. As discussed above, the enablement of a client can be identified by means of certain signatures set by the installation program. Thus, the content is associated with a particular user, thereby avoiding the unauthorized distribution of the content. In this situation, the license is for the specific user. Thus only the licensed user would be able to consume the content, e.g., play the music. In one application, a music service could be provided that delivers music that was purchased by a user, thereby allowing the user to listen to the music at his/her home, at a friend's house, in the user's office or car, or anywhere else that the user identifies him/herself. Any transfer of the content to another device, for example, over the Internet, preferably causes the enabling code to be transmitted along with the content. Any attempt at playing the content on another intelligent machine will thus limit the playing according to the content provider's rules. For example, the content provider may provide that 10 seconds of the content can be played whereafter the user is prompted for credit card information to purchase rights to the use of the rest of the song or video. Thus, in this example, the user is given the opportunity to sample the content or play it a limited number of times before being requested to purchase permanent rights to the use of the content. If the new user chooses not to avail him or herself of the offer, further access will simply be denied to the new user. In this way the invention contemplates controlling the unauthorized copying and distribution of digital content such as music or videos. In both the child protection and music industry scenarios considered above, the communication process invoked by the enabling code, defines what content is to be made available and how it is to be made available. In a preferred embodiment, billing information or other information, once provided by a user, may be retained at some central location, e.g. on the user's machine or a server, to allow the user simply to confirm billings for future transactions without having to reenter the information each time. In one embodiment, the user information may be retained on a portable identification device (PID). In a typical scenario, the user identifies him/herself to the PID. When the user connects to the content provider such as Sony Music, using the PID protocol, the user is prompted to purchases a license, covering one or more songs or albums, confirmation of which is stored on the PID. Thereafter, when the user requests content, the PID is checked to confirm the license status, and content is provided to the licensee subject to a paid up license, allowing the user to consume the content. It will be appreciated that the connection to the content provider may be by way of a request for content, which prompts the checking of the PID for a paid up license. Insofar as no paid up license is identified, the user is first prompted to supply the necessary billing information, whereafter the content is provided. In another scenario, the PID may include the user's medical information, e.g., updated inoculation information, or pointers to the location of the information. Since the content on the PID is enabled content, and is thus associated with rules for consuming or applying the content, the user may include rules defining what device the PID can interface with. Thus, a particular device identifier can be associated with the content to restrict copying or define what can be copied to other devices.

It will be appreciated that, since the rules associated with the enabled content are transferred with the content whenever a transfer of the content takes place, peer to peer communications can take place without compromising the security of the content. Unauthorized consumption will still be prevented since any attempt at playing the content will invoke the associated rules. Thus whether the content is streamed to a new user's player or downloaded to the user's hard drive, the rules for playing the content will be invoked. Only a licensed user can play the entire content. It is conceivable that an enabled user, once he or she has access to the entire content, could play the content from one sound card to another and thereby make an illegal copy. The present invention seeks to limit such activity by including a personal identity or unique digital signature in the content, such as a high frequency signal or some other signal that does not interfere with the enjoyment of the content but nevertheless inserts the user's unique digital signature in the unauthorized copy. Since this digital signature will attach to all subsequent copies, it will allow the user easily to be identified.

The present invention preferably incorporates compression and encryption schemes to further deter would-be offenders. In one embodiment, the content with its rules envelope can, optionally, be compressed. Each item, for example, each song, within the envelope can be individually encrypted to further stymie attempts at circumventing the protection. Similarly, the header information that controls the reading of the files on the CD, may be encrypted.

It will be appreciated that, while the enabling code for enabling the user machine was loaded onto the intelligent machine in each of the examples considered above, it could equally well be retained on one or more servers or other devices, e.g., other computers, smart cards, disks on keyrings, etc., and the code instructions invoked as needed. From the discussion of the implementations, it will also be appreciated that the rules for rendering content, which take the form of rendering code instructions, are not limited to the rules defined in FIGS. 15-17. The enabling code can include any rules relating not only to the content itself but also to other activities of the client machine, such as the acquisition of information from other sources.

The implementations discussed so far, have dealt with user machines in the form of computers, typically connected to a server. However, the invention need not necessarily involve a PC. As mentioned above, the invention also envisages an implementation in which a small portable intelligent device is enabled, such as a smart card or key ring device which includes enabling code in the form of a magnetic strip or chip. In one implementation, the device includes personalized information of the user. For example, it may include preferential settings for the user's motor vehicle seat and mirror positions, or preferences for the user's PC user interface arrangement, or preferential lighting and music settings for a hotel room. Thus by downloading the information on the device to a controller that controls the particular environment, the user can enable the controller to communicate with the portable device. In this way the user can instantaneously adapt any environment to his or her preferences. In one implementation, Bluetooth provides the transport for the protocol.

Numerous other applications of the invention can be envisioned. For example the digital content may comprise a childrens' book or story wherein the enabling code includes rules for requesting user information such as the child's name, pet's name, friends' names, etc. This information could then be included in the story line, in place of the generic names that would be found the presentation of the non enabled version. In this way the child can be the hero in the story and be more of an active participant. It will be appreciated that this would provide for precise tailoring of the digital content. Entire movies, books, advertisements, etc., could use names, identities, and related specifications familiar to the user. For example, a dog's name in a movie or book could be the user's dog, or a name specified by the user or the user's parent or guardian. Likewise, a user's favorite car, song, color, etc., could be dynamically integrated with the content, thus delivering unique content for each user.

It will be appreciated that the above embodiments are given by way of example only, and that the invention can have numerous applications and be implemented in various ways without departing from the gist and nature of the invention. A device can be enabled in any one of a number of ways, and is not limited to the examples given. Similarly the nature of the rules defined by the enabling code, is not limited to the examples given, nor is the invention limited to the particular applications described.

What is claimed is:

1. A method of providing user specific digital content from at least one first machine over a network to a user on a second machine, comprising
verifying the identity of the user, and
presenting user specific digital content to the user based on previously received user information.

2. A method of claim 1, wherein the user information includes demographic information about the user, and optionally one or more of user interest information and user preference information.

3. A method of claim 1, wherein the user information determines the type of content and the manner of presentation of the content.

4. A method of claim 1, further comprising obtaining machine information about the second machine, wherein the step of presenting the user specific digital content, takes into account both the user information and the machine information.

5. A method of claim 4, further comprising obtaining connection information about the bandwidth of the network connecting the first machine to the second machine, wherein the step of presenting the user specific digital content, takes into account the user information, and at least one of the machine information, and the connection information.

6. A method of claim 1, further comprising providing rating information about the digital content that is available for presentation to the user.

7. A method of claim 5, further comprising providing rating information about the digital content that is available for presentation to the user.

8. A method of claim 1, wherein the digital content includes at least one of predetermined web sites, and digital files.

9. A method of claim 8, further comprising providing the user or someone acting for the user with means for providing feedback on the digital content presented to the user.

10. A method of claim 9, wherein the means for providing feedback includes means for providing feedback on at least one of, rating information, new web-site information, and new user information.

11. A method of claim 1, further comprising providing the user with the ability to block advertising on a web site or having it replaced with alternative advertising.

12. A method of claim 2, wherein the demographic information includes at least one of age, sex, language preference, and cultural background of the user.

13. A method of claim 1, wherein the user information is obtained from the user or someone acting for the user.

14. A method of claim 4, wherein the machine information includes hardware and software capabilities of the second machine.

15. A method of claim 14, wherein the hardware capabilities includes at least one of, display resolution, sound card availability, sound card parameters, graphics card availability graphics card parameters, and DVD support.

16. A method of claim 1, wherein the user information is gathered and made available to one or more of the at least one first machine, or another machine, by means of enabling software, that is made available to the second machine.

17. A method of claim 4, wherein the user and machine information are gathered and made available to one or more of the at least one first machine, or another machine, by means of enabling software, that is made available to the second machine.

18. A method of claim 17, wherein the enabling software includes a browser.

19. A method of claim 18, wherein the browser includes a user interface that prevents a user from typing in a web address.

20. A method of claim 5, wherein the connection information is obtained by polling the network connection to the user.

21. A method of claim 17, wherein the enabling software is provided to the user on a portable storage device, or is downloaded to the second machine over the network, or is shipped with the second machine.

22. A method of claim 1, wherein at least part of the digital content presented to the user is downloaded to the second machine over the network.

23. A method of claim 1, wherein at least part of the digital content presented to the user is provided to the user on a portable storage device.

24. A method of claim 22, wherein at least part of the digital content presented to the user is provided to the user on a portable storage device.

25. A method of providing user specific digital content, comprising
gathering, at a first machine, user information provided by a user using a second machine connected to the first machine, and
based on the user information and verification of the identity of the user, providing user specific digital content to the user.

26. A method of claim 25, wherein in the user information includes at least one of demographic information about the user, user interests, and user preferences.

27. A method of claim 25, wherein the user information determines the type of content and the manner of presentation of the content.

28. A method of claim 25, wherein the user specific digital content is provided to the user by means of a physical portable storage medium or over a network to the second machine.

29. A method of presenting digital content to a user on a first machine, comprising
providing remote digital content from at least one second machine to the first machine, over a network;
providing local digital content on a portable storage medium, and
providing means for integrating the remote digital content and the local digital content.

30. A method of restricting access to digital content on a portable storage medium, comprising providing digital content on a portable storage medium, and
providing enabling code on the storage medium, wherein the enabling code includes a first set of code for enabling an intelligent device, a second set of code for enabling the digital content, and identifying means for identifying an enabled device, wherein the enabling of the intelligent device and of the digital content includes the implementation of a protocol for communicating between the intelligent device and the portable storage medium.

31. A method of claim 30, wherein enabling the intelligent device includes obtaining user information from a user of the intelligent device.

32. A method of claim 30, wherein the enabling code defines rules for playing the content.

33. A method of claim 30, wherein at least one of the digital content, and the enabling code, is encoded.

34. A method of claim 30, wherein the digital content and the enabling code are compressed.

35. A method of making digital content available to a user, comprising
providing digital content on a portable storage medium, and -p1 providing enabling code on the storage medium which defines rules for playing the content, wherein the enabling code includes a first set of code for enabling an intelligent device, a second set of code for enabling the digital content, and identifying means for identifying an enabled device, wherein the enabling of the intelligent device and of the digital content includes the implementation of a protocol for communicating between the intelligent device and the portable storage medium.

36. A method of claim 35, wherein the portable storage medium is made available to the user through the mail or at a public pick-up location.

37. A method of claim 36, wherein the portable storage medium is made available free of charge.

38. A method of claim 35, wherein the enabling code includes a browser.

39. A method of claim 38, wherein the browser limits access to predefined web sites.

40. A method of claim 39, wherein the web sites made available to a particular user are based on user information collected about said user.

41. A method of claim 38, wherein the browser includes a user interface for entering at least one of user information about the user, and feedback information about the content.

42. A method of claim 41, wherein the user information includes at least one of user demographic information, user interests, and user preferences.

43. A method of claim 42, wherein the digital content provided to a user is based on the user information.

44. A method of claim 41, wherein the feedback information includes at least one of, new websites of interest to the user, and information about new users.

45. A method of claim 38, wherein the storage medium further includes code for determining at least one of, the capabilities of the client machine, and the bandwidth available on the network.

46. A method of securing digital content, comprising
associating enabling code with the digital content, wherein the enabling code defines rules for playing the content on an enabled machine, and
enabling a machine to play the content according to the rules, wherein the enabling code defines a communication protocol for communicating the rules and the digital content.

47. A method of claim 46, wherein the enabling code includes code for associating a machine identifier with the content.

48. A method of claim 47, wherein the machine identifier identifies all machines enabled to play the content.

49. A method of claim 46, wherein the rules include a request for user information.

50. A method of claim 49, wherein the user information includes at least one of demographic information about the user, user interests, and user preferences, and wherein the playing of the content is adapted according to the user information.

51. A method of claim 49, wherein the user information includes billing information.

52. A method of claim 46, wherein the content and at least one of the rendering and enabling code are provided on a transportable medium.

53. A method of claim 52, wherein the transportable medium is a compact disk, and wherein the content and code are compressed.

54. A method of claim 46, wherein the content is one or more of audio, video, graphics, and images.

55. A method of claim 46, wherein the rules include instructions to the enabled machine to access at least a second source of digital content.

56. A method of claim 55, wherein the machine is connected to the second source by a network.

57. A method of claim 56, wherein the network is the internet, and wherein at least part of the digital content and at least part of the digital content from the second source are rendered simultaneously on the machine.

58. A method of claim 46, further comprising playing the content using a custom user interface.

59. A method of claim 58, wherein the enabling code includes a browser which includes the custom user interface.

60. A method of claim 59, wherein the user interface includes means for collecting the user information.

61. A method of claim 60, wherein the user information is used to further customize the user interface.

62. A method of claim 46, wherein the enabling code includes code for collecting machine information about the capabilities of the machine.

63. A method of controlling the rendering of digital content communicated to an intelligent device, comprising
providing digital content and enabling code to an enabled intelligent device, wherein the enabling code includes a protocol for communicating with the enabled device, and code for verifying the identity of a user of the enabled device.

64. A method of claim 63, wherein the enabled device includes a user interface that excludes a Web address entry location.

65. A method of claim 64, wherein the user interface includes means for gathering at least user demographic information.

66. A method of claim 63, wherein the enabling code prompts the enabled device to download content from a second source, taking into account at least some of the demographic information.

67. A method of claim 65, wherein the enabled device is connected to the Internet and wherein the enabling code prompts the enabled device to download content from the Internet taking into account at least some of the demographic information.

68. A method of claim 67, wherein the enabling code includes means for gathering at least one of information about the capabilities of the intelligent device, and the connection to the Internet.

69. A method of communicating digital content from a first device to a second device, comprising
gathering user demographics information about the user of the second device,
verifying the identity of the user, and
transmitting digital content from the first device to the second device, wherein the digital content is tailored according to the gathered information.

70. A method of claim 69, further comprising gathering at least one of second device capabilities, user preferences, and user interests.

71. A method of claim 69, wherein the first device is a portable storage device.

72. A method of claim 69, wherein the first and second devices are connected by a network.

73. A method of claim 69, wherein feedback information is gathered subsequent to transmitting at least part of the digital content.

74. A method of claim 73, wherein the feedback information includes interacting activities between the user and the content.

75. A method of claim 74, wherein the gathering of feedback information includes monitoring the number of times the content is listened to or viewed.

76. A method of claim 75, wherein tailoring the content includes denying access to at least part of the content.

77. A method of claim 75, wherein tailoring the content includes denying access to the content after a predefined number of times.

78. A method of claim 73, wherein the feedback information includes billing information.

79. A method of claim 69, further comprising providing the user with a user interface.

80. A method of claim 69, further comprising providing a second set of digital content to the second device from a second source, taking into account the gathered information.

81. A method of claim 80, wherein the second source is a storage device that is readable by the second device, or is a third device connected to the second device through a network.

82. A method of conforming an electronically controlled environment to a user's specifications, comprising
downloading user information to a controller of the electronically controlled environment from a portable device, wherein the user information includes user preferences.

83. A method of claim 82, wherein the user information further includes at least one of user demographic information and user interests.

84. A method of claim 83, wherein the downloading to the controller is achieved through any one of a readable magnetic card strip, a complementary plug and socket connection, and wireless transmission.

85. A method of claim 82, wherein the device includes a storage medium, and the user information is stored on the storage medium.

86. A method of claim 85, wherein the device includes an interface for interfacing with a computer system for entering the user information into the device.

87. A file format comprising
content or pointers to content, and
rules for consuming the content by a user, wherein the rules are stored in conjunction with the content or pointers, and wherein the rules include software code for verifying the identity of the user.

88. A file format of claim 87, wherein the file format is only accessible by an enabled device that has been enabled to communicate according to a predefined protocol.

89. A file format system comprising
content or pointers to content, wherein the content is stored according to at least one file format, and
a protocol, wherein the protocol includes rules for accessing the content.

90. A method of obtaining digital content at a first device from at least one second device, comprising
providing a facility for exchanging data between the first device and the at least one second device, wherein data from the first device includes user identifying information about the user of the first device, and
presenting digital content to the first device based on data received from the first device, wherein the user determines what data to provide to a particular at least one second device.

91. A method of claim 90, wherein at least one of the nature of the content and the manner of presentation, is adjusted depending on the data received from the first device.

92. A method of claim 91, wherein the data received from the first device includes demographic information about the user.

93. A method of claim 93, wherein, in the absence of the user supplying demographic information, the second device presents the content according to predetermined default parameters.

94. A method of claim 92, wherein the data received from the first device further includes at least one of user preferences, user interests, and first device parameters.
